(19) United States
(12) Patent Application Publication
(10) Pub. No.: US 2025/0149612 A1
(43) Pub. Date: May 8, 2025

(54) GUIDES AND METHODS FOR BATTERY CELL CURRENT COLLECTOR TAB CONSOLIDATION

(71) Applicant: GM Global Technology Operations LLC, Detroit, MI (US)

(72) Inventors: Kevin Dongjun Kim, Troy, MI (US); James Chung, Troy, MI (US); Young Nam Kim, Troy, MI (US); Virendra Kumar Dewangan, Maharashtra (IN); Varsha Tadwalkar, Maharashtra (IN); Christopher Schlaupitz, White Lake, MI (US)

(21) Appl. No.: 18/502,633

(22) Filed: Nov. 6, 2023

(51) Int. Cl. H01M 10/04; H01M 50/536; H01M 50/54

(52) U.S. Cl. CPC H01M 10/0404; H01M 50/536; H01M 50/54

(57) ABSTRACT

A system for consolidating tabs of a battery cell includes a tab guide configured to receive a plurality of tabs extending from electrode layers of a cell stack, the cell stack configured to be disposed in a housing to form the battery cell, the tab guide including opposing guide components configured to be positioned between the cell stack and a weld plate, the tab guide configured to receive the plurality of tabs between the opposing guide components. The system also includes an actuator configured to be operated to move one or more of the opposing guide components to deform a length of one or more tabs between the cell stack and the weld plate.

### INTRODUCTION

The subject disclosure relates to batteries, and more particularly to manufacture and assembly of battery cells.

Battery cells are used in various applications, such as automotive applications (e.g., in electric and hybrid vehicles). For example, electric and hybrid vehicle battery systems include battery modules having multiple battery cells. Battery cells may be pouch-type cells or other types of cells, and typically include multiple layers of both anode material and cathode material. Anode layers are electrically connected by welding a stack of anode tabs, and cathode layers are electrically connected by welding a stack of cathode tabs.

### SUMMARY

In one exemplary embodiment, a system for consolidating tabs of a battery cell includes a tab guide configured to receive a plurality of tabs extending from electrode layers of a cell stack, the cell stack configured to be disposed in a housing to form the battery cell, the tab guide including opposing guide components configured to be positioned between the cell stack and a weld plate, the tab guide configured to receive the plurality of tabs between the opposing guide components. The system also includes an actuator configured to be operated to move one or more of the opposing guide components to deform a length of one or more tabs between the cell stack and the weld plate.

In addition to one or more of the features described herein, the actuator is operated prior to welding the plurality of tabs to the weld plate.

In addition to one or more of the features described herein, the system includes a bonding device configured to engage the plurality of tabs and bond the plurality of tabs together to form a tab stack.

In addition to one or more of the features described herein, the system includes a welding device configured to weld the tab stack to the weld plate.

In addition to one or more of the features described herein, the bonding device is moveable with at least one of the opposing guide components, so that the bonding device is configured to engage the plurality of tabs when one or more of the opposing guide components is moved to deform the length of the one or more tabs.

In addition to one or more of the features described herein, the opposing guide components are configured to deform the length of the one or more tabs by applying a curvature to the length of the one or more tabs.

In addition to one or more of the features described herein, the opposing guide components include a first guide component having a first member and a second guide component having a second member, the first member and the second member extending in a direction that is parallel to a direction of movement of one or more of the opposing guide components.

In addition to one or more of the features described herein, the first member is offset from the second member in a direction perpendicular to the direction of movement.

In addition to one or more of the features described herein, at least one of the first member and the second member includes a convex end.

In addition to one or more of the features described herein, at least one of the first member and the second member includes an S-shaped end.

In another exemplary embodiment, a method of consolidating tabs of a battery cell includes acquiring a cell stack, the cell stack configured to be disposed in a housing to form the battery cell, the cell stack having a plurality of tabs extending from electrode layers of the cell stack, and inserting the plurality of tabs through a tab guide and between opposing guide components of the tab guide, the opposing guide components positioned between the cell stack and a weld plate. The method also includes operating an actuator to move one or more of the opposing guide components and deform a length of one or more tabs between the cell stack and the weld plate, wherein the actuator is operated prior to welding the plurality of tabs to the weld plate.

In addition to one or more of the features described herein, the method includes engaging the plurality of tabs by a bonding device to bond the plurality of tabs together and form a tab stack.

In addition to one or more of the features described herein, the method includes welding the tab stack to the weld plate after deformation of the length of the one or more tabs and after engaging the plurality of tabs by the bonding device.

In addition to one or more of the features described herein, the opposing guide components are configured to deform the length of the one or more tabs by applying a curvature to the length of the one or more tabs.

In addition to one or more of the features described herein, the opposing guide components include a first guide component having a first member and a second guide component having a second member, the first member and the second member extending in a direction that is parallel to a direction of movement of one or more of the opposing guide components.

In addition to one or more of the features described herein, the first member is offset from the second member in a direction perpendicular to the direction of movement.

In addition to one or more of the features described herein, at least one of the first member and the second member includes at least one of a convex end and an S-shaped end.

In yet another exemplary embodiment, a computer program product includes a computer-readable memory that has computer-executable instructions stored thereupon, the computer-executable instructions when executed by a processor cause the processor to perform operations. The operations include acquiring a cell stack, the cell stack configured to be disposed in a housing to form a battery cell, the cell stack having a plurality of tabs extending from electrode layers of the cell stack, and inserting the plurality of tabs through a tab guide and between opposing guide components of the tab guide, the opposing guide components positioned between the cell stack and a weld plate. The operations also include operating an actuator to move one or more of the opposing guide components and deform a length of one or more tabs between the cell stack and the weld plate, where the actuator is operated prior to welding the plurality of tabs to the weld plate.

In addition to one or more of the features described herein, the operations include engaging the plurality of tabs by a bonding device to bond the plurality of tabs together and form a tab stack.

In addition to one or more of the features described herein, the opposing guide components are configured to deform the length of the one or more tabs by applying a curvature to the length of the one or more tabs.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts an example of a battery cell;

FIG. 2 depicts a system for manufacturing a battery cell, in accordance with an exemplary embodiment;

FIG. 3 depicts a pre-weld tab guide in an open position, in accordance with an exemplary embodiment;

FIG. 4 depicts the pre-weld tab guide of FIG. 3 in a closed or actuated position, in accordance with an exemplary embodiment;

FIG. 5A depicts an example of a conventional tab guide;

FIGS. 5B-5D depict examples of a pre-weld tab guide, in accordance with an exemplary embodiment;

FIG. 6 is a flow diagram of a method of consolidating electrode layer tabs and/or manufacturing a battery cell, in accordance with an exemplary embodiment;

FIGS. 7A and 7B depict a pre-weld tab guide in an open position and in a closed or actuated position, in accordance with an exemplary embodiment;

FIG. 8 depicts a computer system, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for facilitating attachment and electrical connection of electrodes (anodes and cathodes) in a battery cell. An embodiment of a system for consolidating and joining portions of electrodes or electrode layers includes a tab guide configured to receive a plurality of electrode connection portions (referred to as “tabs” or “tab foils”) and consolidate the tabs in preparation for welding or otherwise attaching the tabs to a weld plate, bus, connector or other electrically conductive component. The tabs (or portions of tabs) that are brought together in preparation for welding are referred to as a “tab stack.” The system may be part of a battery cell manufacturing system.

The tab guide includes at least one feature or component that is configured to deform portions of the electrodes as they are consolidated, and apply a curvature to a portion of at least one electrode. The deformation or curvature increases the length of portions of at least some of the tabs behind the stab stack. The extra length provided by imparting the curvature acts as a stress reliever to accommodate forces applied to the tabs 22 by a subsequent operation. For example, the extra length provides additional tolerance when welding, which allows for the tabs 22 to be pulled without tearing or other damage that can occur during a welding process.

In an embodiment, the tab guide is part of a consolidation system. The consolidation system includes opposing members that define a gap or opening through which a set of electrode layer tabs (e.g., anode or cathode foils) is inserted. The consolidation system may include a platform or other support structure that retains a weld plate, connector or other conductive component. In use, the set of tabs are inserted through the opposing members so that a portion of each tab is aligned with the conductive component (also referred to herein as a “contact component” or “weld plate”).

After the tabs are inserted, the opposing members are brought together to induce a curvature in at least one or all of the tabs, or otherwise increase the length of at least one tab behind the tab stack (i.e., between the contact component and a battery cell stack). A bonding device, such as a body having a flat surface (and/or a body or device for heating the tabs in a tab stack), may engage the tab stack to bond the tab portions in the tab stack together. The tab stack may then be welded to the weld plate.

Embodiments described herein present numerous advantages and technical effects. The embodiments provide for an improved manufacturing process that facilitates proper attachment and electrical connection of electrode tabs. For example, by providing a pre-weld tab guide as described herein, stresses on tab layers when welding are reduced. This can prevent tears and other damage that are often associated with existing welding processes.

For example, current tab guides are designed to gather tabs toward a central location relative to a cell stack using a flat tab guide. With such designs, tabs that extend into an interior of a tab stack (between outer tabs) can be easily stretched and weakened, thereby potentially causing tears. Embodiments address this problem by providing a pre-weld tab guide that serves to prevent stretching of tabs.

FIG. 1 depicts an example of a battery cell 10. The battery cell includes a housing, which may be a flexible housing such as an envelope or pouch 12, that is sealed to enclose a plurality of electrodes. The pouch 12 may be an aluminum laminated foil or other suitable pouch material. Embodiments described herein are not limited to any particular type of battery cell, or any particular shape, size or material of the electrodes and the housing. For example, embodiments may be applicable to prismatic cells and other types of cells.

The battery cell 10 includes a plurality of layers that form negative electrodes or anodes, and positive electrodes or cathodes. The anodes are made from electrically conductive anode layers 14, and the cathodes are made from electrically conductive cathode layers 16. The anode layers 14 and the cathode layers 16 are configured as thin sheets or foils. A separator 18 made from an electrically insulating material (e.g., polymer or ceramic) is disposed between each anode layer 14 and adjacent cathode layer 16. An active material 20, such as a graphite or a material including Lithium, is disposed in the pouch 12 between the various layers. These internal layers constitute a battery cell stack 21.

It is noted that the number of electrodes is not limited to the number shown in FIG. 1. The battery cell 10 may have any number of anode layers 14 and any number of cathode layers 16. For example, the battery cell 10 may have hundreds of individual foil layers forming the electrode layers.

As shown in FIG. 1, each anode layer 14 includes a portion 22 that extends away from the interior of the cell 10 and allows for electrical connection of each anode layer 14 with another anode layer 14. This portion 22 is also referred to as a tab 22 or connection tab 22. Although not shown, the cathode layers 16 include tabs so that the cathode layers 16 can be connected.

Portions of the tabs 22 (or a subset thereof) are stacked together as a tab stack 24. The portions making up the tab stack 24 are welded together by, for example, a primary ultrasonic weld. The weld may be a solid-state weld joint formed through ultrasonic welding or a fusion weld joint formed through laser welding, although other metal-to-metal joining procedures may be used.

The tab stack 24 is attached to an electrically conductive component 26 (e.g., via the weld) that serves as a connector. The connector 26 forms a negative terminal. The cathode layers 16 may be similarly welded to a positive terminal (not shown) that extends to an exterior of the pouch 12. The connector 26 may be configured as a weld plate, and provides a contact point for welding the tab stack 24 together.

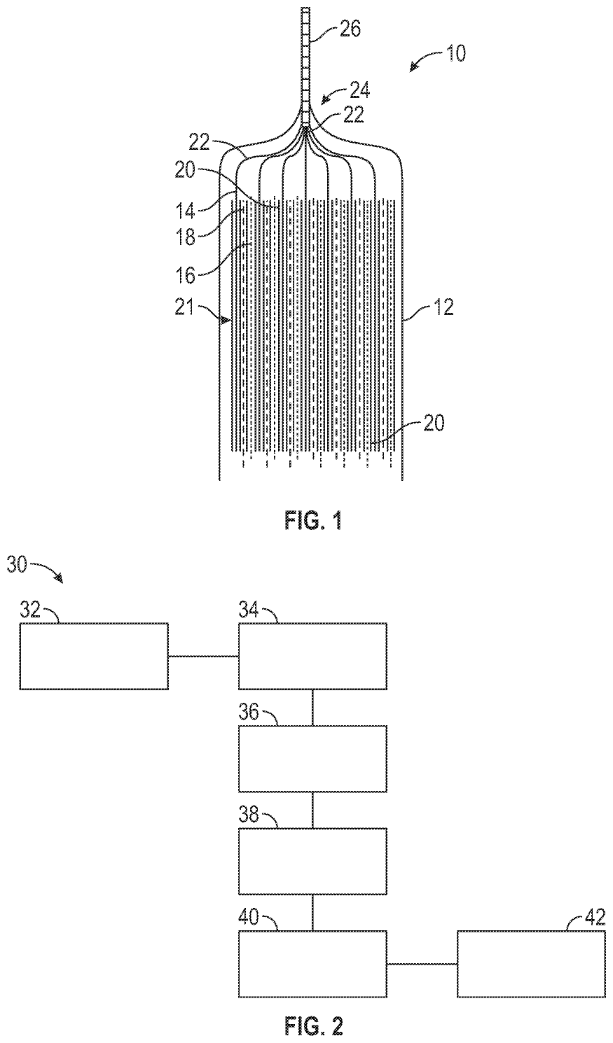

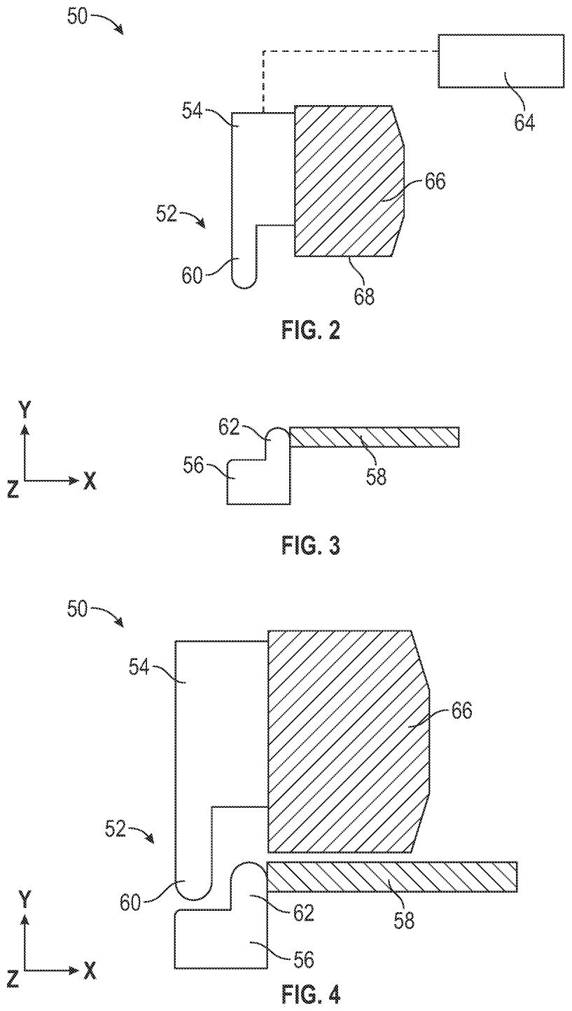

FIG. 2 depicts an example of a manufacturing system 30 for manufacturing battery cells. The manufacturing system 30 includes various manufacturing stations, which may be controlled or operated by a computer system, a human operator or a combination thereof. As described herein, a “station” refers to any number, combination and layout of equipment and is not intended to limit the manufacturing system 30 to any specific machine or combination of machines.

The manufacturing system 30 includes, for example, an active material processing station 32 for preparing active materials to be applied to electrode layers. The system 30 may also include a coating station 34 for coating electrodes with the active materials. The manufacturing system 30 also includes an electrode cutting station 36, which can be used to form electrode layers and tabs from sheets of electrode material (e.g., copper and aluminum sheets).

The system 30 also includes a stacking station 38 for forming the various layers of a battery stack, and a welding station 40 for welding electrode layer tabs. The welding station 40 may include pre-weld tab guides as described herein, in combination with welding equipment.

The system 30 may include other stations for performing subsequent processes to complete battery cells. Examples include an assembly station 42 (e.g., for pouch construction, sealing, electrolyte filling, etc.), and stations for manufacturing battery assembles, such as battery packs and/or modules.

For example, battery cells can be installed in a battery assembly. The battery assembly may be a battery module having a plurality of electrically connected battery cells, such as a battery module that is incorporated into a vehicle (e.g., an electric or hybrid vehicle) as part of a battery pack.

FIGS. 3 and 4 depict an embodiment of a tab connection assembly 50 that is configured to consolidate tab stacks of battery cells, and electrically connect the tab stacks to weld plates or other connectors. FIG. 3 shows the assembly 50 in an open position, and FIG. 4 shows the assembly 50 in an actuated or closed position.

The tab connection assembly 50 includes a pre-weld tab guide 52 having opposing guide components 54 and 56, which are activated prior to welding. The guide component 54 and/or 56 is/are moveable relative to a conductive component such as a weld plate 58. The weld plate 58 defines a flat surface, against which inserted tabs are brought together for subsequent welding to the weld plate 58. The weld plate 58 may be any suitable conductive component or body, and is not limited to any particular size or shape.

One or both of the guide components 54 and 56 include a member or other feature that causes sections or lengths of at least some of the tabs 22 to curve or otherwise deform behind the weld plate 58 (i.e., between the weld plate 58 and the cell stack 21) when the guide components 54 and 56 are brought together. In an embodiment, one or both of the guide components 54 and 56 include a protrusion or member that extends in a direction that corresponds to a direction of movement of a guide component or guide components when the pre-weld tab guide 52 is actuated.

In the embodiment of FIGS. 3 and 4, the pre-weld tab guide 52 includes a first (upper) member 60 extending from the guide component 54 (also referred to as an “upper guide component”) toward the guide component 56 (also referred to as a “lower guide component”) in the y-direction. The lower guide component 56 includes a second (lower) member 62 that extends toward the upper guide component 54. The first member 60 is offset from the second member 62 in a direction (x-direction) that is perpendicular to the direction of extension of the members.

The upper guide component 54 and/or the lower guide component 56 are moveable in the y-direction to actuate the tab guide 52 by bringing the upper and lower members 60 and 62 toward each other. One or both of the members 60, 62 may be moved, for example, by operating any suitable actuator 64. For example, one member may be moved while the other remains stationary, or both members may be moved simultaneously toward a center of the cell stack (in the y-direction).

The tab connection assembly 50 also includes a bonding device 66, which is moveable with one or more guide components and configured to bond inserted tabs 22 to form the tab stack 24, and facilitate subsequent welding to the weld plate 58. The bonding device 66 is configured to bond the tabs 22 by compression, application of heat or both.

In the embodiment of FIGS. 3 and 4, the bonding device 66 is a body attached to the upper guide component 54, or otherwise moveable with the upper guide component 54. The body includes a flat surface 68 facing the weld plate 58. The weld plate 58 may be attached to the lower guide component 56 or otherwise moveable therewith.

As shown in FIG. 4, when the guide components 54 and 56 are brought toward one another to an actuated position, the opposing members 60 and 62 form a curved or tortuous path that causes the length of a section of at least some tabs to increase. A “section” of a tab as described herein refers to part of the tab that extends from the cell stack and is disposed between the cell stack 21 and a tab stack 24. In the actuated position, the guide members 60 and 62 impart a curvature to the section of at least some of the tabs 22 (including tabs in the interior of the tab stack between the outermost tabs), thereby increasing the length of sections of at least the interior tabs. This increased length acts as a stress reliever and provides tolerance to the tabs 22, so that the tabs 22 can accommodate stresses without tearing during a welding process.

In the embodiment of FIGS. 3 and 4, the guide members 60 and 62 each have a dome-shaped or convex end, which can be configured as desired (e.g., by selecting a width and/or radius of the end). The guide members 60 and 62 are not so limited, and can have any suitable shape, size and length.

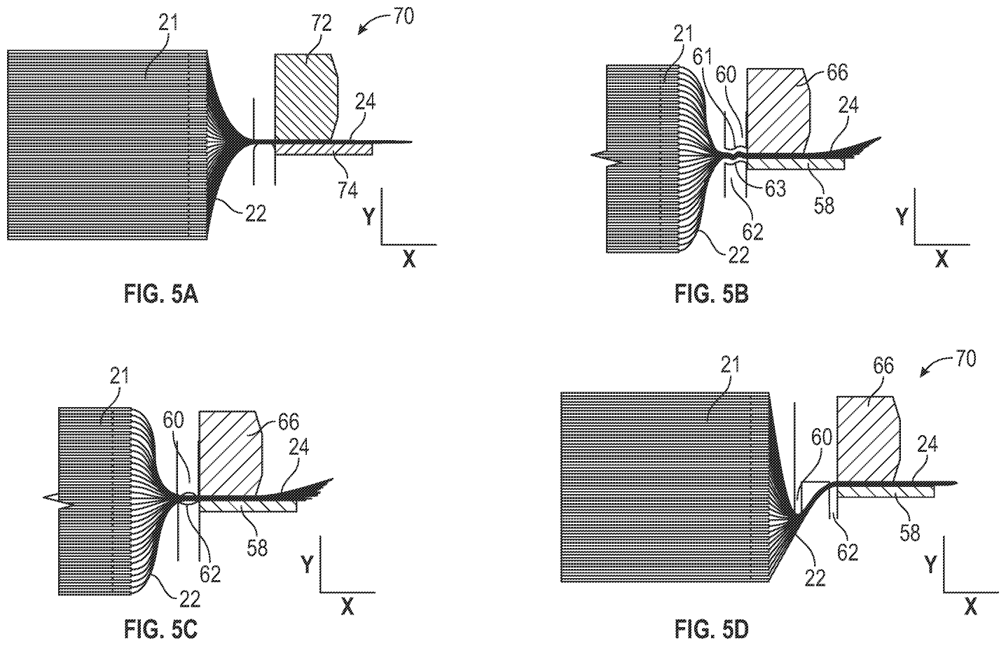

FIGS. 5A-5D show examples of other guide member and guide component designs. FIGS. 5A-5D also illustrate examples of increased lengths of tab sections behind a weld plate. Specifically, FIG. 5A shows an example of a conventional flat tab guide 70, which includes a bonding device 72 and a weld plate 74.

FIGS. 5B-5D show examples of guide component designs, and demonstrate the increase in length that these designs impart to tab sections. FIG. 5B shows an example on which the upper and lower guide members 60 and 62 have complementary S-shaped ends (i.e., ends that fit together when brought in contact with each other).

In the example of FIG. 5C, the lower guide member 62 has a dome shaped or convex end 63. The upper guide member 60 may have a complementary concave end 61, or have a different shape.

The example of FIG. 5D shows an example in which the ends 61 and 63 of the guide members 60 and 62 are offset in the x-direction. The guide member ends 61 and 63 each define a rectangular profile.

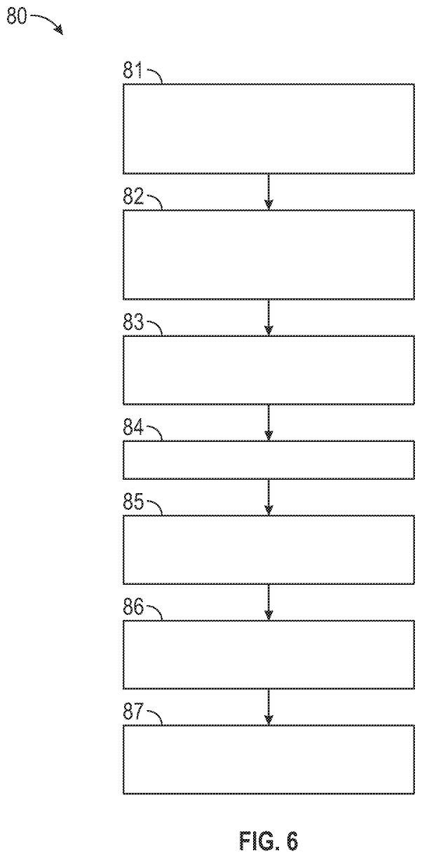

FIG. 6 illustrates embodiments of a method 80 of manufacturing a battery cell. The method 80 (or parts thereof) may be performed by any suitable processing device or devices, such as one or more controllers of the manufacturing system 30 and/or the connection system 50, but is not so limited.

The method 80 includes a number of steps or stages represented by blocks 81-87. The method 80 is not limited to the number or order of steps therein, as some steps represented by blocks 81-87 may be performed in a different order than that described below, or fewer than all of the steps may be performed.

The method 80 is described in conjunction with forming a tab stack from anode tabs and welding anode tabs to an anode weld plate. It is understood that the method 80 is similarly applicable to cathode tabs.

At block 81, electrodes are created or acquired, which include anode sheets and cathode sheets made from a coated conductive material. For example, the anode sheets are made from copper, and the cathode sheets are made from aluminum.

Anode and cathode sheets are coated, cut, trimmed and/or otherwise processed to create anode and cathode layers, and the anode layers and cathode layers are assembled with other layers (e.g., separator layers) to form the cell stack 21. Each anode and cathode layer has a respective tab 22 extending from the cell stack.

At block 82, anode tabs 22 are inserted through opposing guide components and members of a pre-weld tab guide 52.

At block 83, the tab guide 52 is operated, for example, by moving the opposing guide members 60 and 62 toward each other until the bonding device 66 and/or weld plate 58 engages the tabs 22.

The guide components 54 and 56, and their respective members 60 and 62, are moved in opposite directions and brought toward each other. As the members 60 and 62 approach each other, sections of the tabs 22 behind the weld plate 58 (i.e., between the cell stack 21 and the weld plate 58) are deformed and pulled, such that a curvature is introduced to at least a set of tabs 22 internal to the tab stack 24 (i.e., in the middle and/or between outer tabs). As the tabs 22 are not yet bonded, individual tabs 22 can be pulled to form curvatures without significant stretching or tensile deformation. This curvature results in an increase in the length of tab sections between the cell stack 21 and the tab stack 24. When the guide components 54 and 56 are opened, the increase in length acts as a stress reliever when forces are imposed by subsequent operations (e.g., welding).

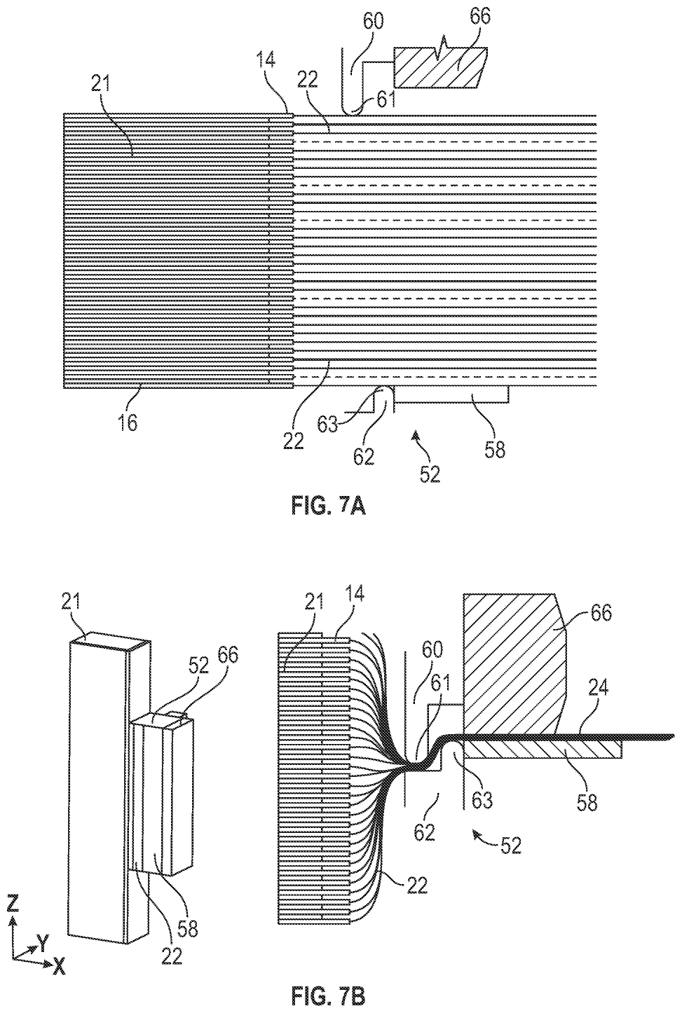

For example, as shown in FIGS. 7A and 7B, the tabs 22 are inserted through the tab guide 52, so that an end portion of each tab 22 extends though the guide members 60 and 62 and rests atop the weld plate 58. FIG. 7A shows the tabs 22 after insertion and when the tab guide 52 is in an open position.

FIG. 7B shows the tab guide 52 in a closed position. As can be seen, the members 60 and 62 cause a significant curvature behind the tab stack 24, and thereby increase the length of sections of at least the middle tabs 22.

At block 84, a suitable bonding device is used to bond tab portions forming a tab stack 24 to each other and a weld plate 58 or other connector. For example, referring to FIGS. 7A and 7B, closure of the tab guide 52 causes the bonding device 66 to compress the tab stack 24 in conjunction with the weld plate 58.

At block 85, the tab guide is opened, and the tab stack 24 is subsequently welded to the weld plate 58. Any suitable joining or welding process may be used. During the welding process, various forces, such as pulling forces, may be exerted on the tabs 22. The extra length provided by imparting the curvature allows for the tabs 22 to be pulled without tearing.

At block 86, additional steps are performed to complete assembly of the battery cell 10, such as installing the welded electrodes in a housing (e.g., pouch or rigid housing) with separator layers, quality inspection, electrolyte filling, housing sealing and others.

At block 87, the battery cell 10 may be installed in a battery assembly, such as a battery pack or battery module. For example, the battery cell 10 is installed in a battery module with other cells, and the battery module is installed in an electric or hybrid vehicle.

It is noted that the manufacturing system 30, the connection system 50 and the method 80 are not intended to limit embodiments to any specific manufacturing process. Any suitable manufacturing system or process that includes some form of cell tab creation and electrical connection may be used.

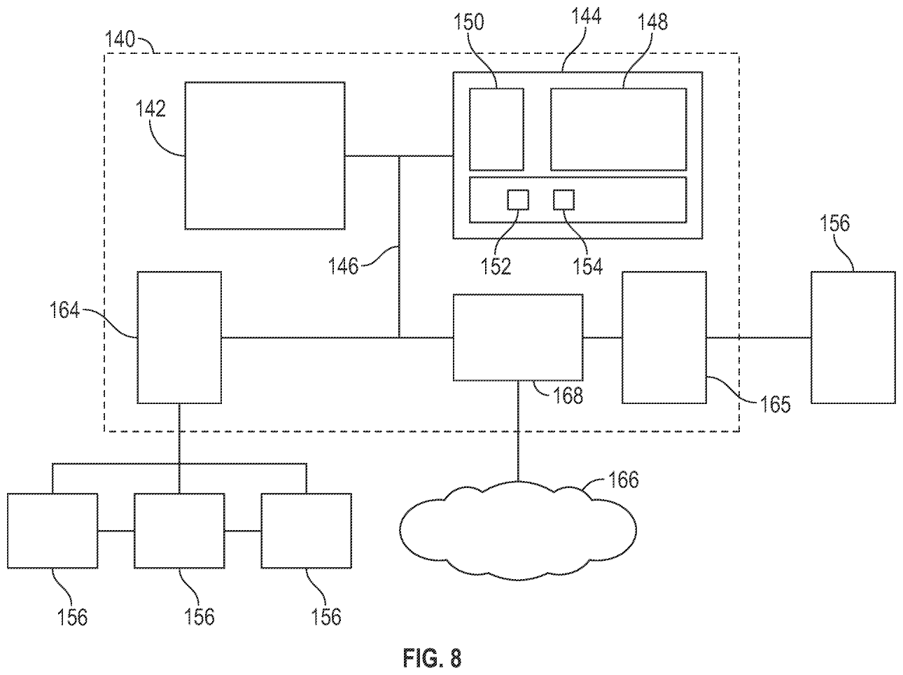

FIG. 8 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to preparation and insertion of tabs as described herein. A control module or modules 154 may be included for controlling a pre-weld tab guide. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for consolidating tabs of a battery cell, comprising:
a tab guide configured to receive a plurality of tabs extending from electrode layers of a cell stack, the cell stack configured to be disposed in a housing to form the battery cell, the tab guide including opposing guide components configured to be positioned between the cell stack and a weld plate, the tab guide configured to receive the plurality of tabs between the opposing guide components; and
an actuator configured to be operated to move one or more of the opposing guide components to deform a length of one or more tabs between the cell stack and the weld plate.

2. The system of claim 1, wherein the actuator is operated prior to welding the plurality of tabs to the weld plate.

3. The system of claim 1, further comprising a bonding device configured to engage the plurality of tabs and bond the plurality of tabs together to form a tab stack.

4. The system of claim 3, further comprising a welding device configured to weld the tab stack to the weld plate.

5. The system of claim 3, wherein the bonding device is moveable with at least one of the opposing guide components, so that the bonding device is configured to engage the plurality of tabs when one or more of the opposing guide components is moved to deform the length of the one or more tabs.

6. The system of claim 1, wherein the opposing guide components are configured to deform the length of the one or more tabs by applying a curvature to the length of the one or more tabs.

7. The system of claim 1, wherein the opposing guide components include a first guide component having a first member and a second guide component having a second member, the first member and the second member extending in a direction that is parallel to a direction of movement of one or more of the opposing guide components.

8. The system of claim 7, wherein the first member is offset from the second member in a direction perpendicular to the direction of movement.

9. The system of claim 7, wherein at least one of the first member and the second member includes a convex end.

10. The system of claim 7, wherein at least one of the first member and the second member includes an S-shaped end.

11. A method of consolidating tabs of a battery cell, comprising:
acquiring a cell stack, the cell stack configured to be disposed in a housing to form the battery cell, the cell stack having a plurality of tabs extending from electrode layers of the cell stack;
inserting the plurality of tabs through a tab guide and between opposing guide components of the tab guide, the opposing guide components positioned between the cell stack and a weld plate; and
operating an actuator to move one or more of the opposing guide components and deform a length of one or more tabs between the cell stack and the weld plate, wherein the actuator is operated prior to welding the plurality of tabs to the weld plate.

12. The method of claim 11, further comprising engaging the plurality of tabs by a bonding device to bond the plurality of tabs together and form a tab stack.

13. The method of claim 12, further comprising welding the tab stack to the weld plate after deformation of the length of the one or more tabs and after engaging the plurality of tabs by the bonding device.

14. The method of claim 11, wherein the opposing guide components are configured to deform the length of the one or more tabs by applying a curvature to the length of the one or more tabs.

15. The method of claim 11, wherein the opposing guide components include a first guide component having a first member and a second guide component having a second member, the first member and the second member extending in a direction that is parallel to a direction of movement of one or more of the opposing guide components.

16. The method of claim 15, wherein the first member is offset from the second member in a direction perpendicular to the direction of movement.

17. The method of claim 15, wherein at least one of the first member and the second member includes at least one of a convex end and an S-shaped end.

18. A computer program product comprising a computer-readable memory that has computer-executable instructions stored thereupon, the computer-executable instructions when executed by a processor cause the processor to perform operations comprising:
acquiring a cell stack, the cell stack configured to be disposed in a housing to form a battery cell, the cell stack having a plurality of tabs extending from electrode layers of the cell stack;
inserting the plurality of tabs through a tab guide and between opposing guide components of the tab guide, the opposing guide components positioned between the cell stack and a weld plate; and
operating an actuator to move one or more of the opposing guide components and deform a length of one or more tabs between the cell stack and the weld plate, wherein the actuator is operated prior to welding the plurality of tabs to the weld plate.

19. The computer program product of claim 18, wherein the operations include engaging the plurality of tabs by a bonding device to bond the plurality of tabs together and form a tab stack.

20. The computer program product of claim 18, wherein the opposing guide components are configured to deform the length of the one or more tabs by applying a curvature to the length of the one or more tabs.
